(19) United States
(12) Patent Application Publication
(10) Pub. No.: US 2020/0217975 A1
(43) Pub. Date: Jul. 9, 2020

(54) PASSIVE ACOUSTIC SOURCE POSITIONING

(71) Applicants: Erik GODOY, Nesbru (NO); POLARCUS SHIPHOLDING AS, Oslo (NO)

(72) Inventors: Hugo LIMA SANTOS, Dubai (AE); Gary WINFIELD, Dubai (AE)

(21) Appl. No.: 16/637,782

(22) PCT Filed: Aug. 7, 2018
(86) PCT No.: PCT/NO2018/050202

§ 371 Date: Feb. 10, 2020

(30) Foreign Application Priority Data
Aug. 11, 2017 (NO) 20171338

(51) Int. Cl. G01V 1/137; G01V 1/38

(52) U.S. Cl. CPC G01V 1/137; G01V 1/3835

(57) ABSTRACT

A method of passive acoustic source positioning of sea-going platforms is disclosed. The method includes positioning of RGPS pods and AHRS acoustic sensors on a fixed surface. Further, the method includes positioning an air gun including gun strings and positioning a set of reflective nodes (sonar bells) along each gun string on each gun cluster position with known fixed offsets. The reflective nodes will reflect the echo from the AHRS acoustic sensor, which will accurately capture their position and transmit the position data to a surface vessel.

### BACKGROUND OF THE INVENTION

The present invention relates to underwater acoustic source positioning system and method.

It is an increasingly demanded requirement that individual gun clusters are positioned as accurately as possible for high end surveys and geophysical techniques.

Underwater reflective targets are typically acoustic reflectors, which are generally used in sonar systems such as, for example sonar bells, for identifying and accurately locating underwater objects. Conventional reflective targets are cylindrical, bell-shaped, or spherical, or hemispherical. An acoustic reflector is suitable for use as a reflective target in marine seismic surveys to generate acoustic signals with source location and re-location applications. In order to be effective an acoustic reflector needs to be capable of producing strong reflected acoustic signals relative to the strength of the acoustic energy reflected off strategically positioned targets on the gun clusters and distinguishable from other false targets.

U.S. patent application Ser. No. 11/795,211 discloses an acoustic reflector suitable for use as a reflective target for navigational aids and for location and re-location applications.

U.S. patent application Ser. No. 13/976,234 discloses a method of identifying and locating an underwater reflector, the method includes the step of measuring the acoustic diameter of an object and comparing that diameter with known acoustic diameters for underwater acoustic reflectors that may be present in the search area, and thus accepting or rejecting the reflected acoustic wave as being one potentially of interest. Where the total target strength of an echo is measured and the echo is rejected as potentially coming from an underwater acoustic reflector of interest if the target strength is less than a predetermined minimum. The target is being rejected as being an acoustic reflector of interest if the measured characteristics do not match the known characteristics of a reflector of interest.

However, this existing solution is not related to Seismic Source positioning applications; it is also not related to moving equipment that is under tow by the same vessel that is surveying effectively its own surveying equipment.

The current technique to position the gun clusters provides inaccurate positioning measurements due to numerous assumptions such as relying on known fixed offsets to position moving underwater gun clusters. Further, underwater acoustic energy sources positioning is inaccurate due to high dynamics and geometry. Further, underwater acoustic sensor is not co-located with surface Global Navigation Satellite System (GNSS) sensors and may be positioned on a flexible chain or rope or beam. The air gun, which includes several gun clusters, each submersed in water and suspended from a flotation device that supports the gun clusters is flexible and approximately 15 meter long. Further, the gun clusters are placed on the chains, having variable depth ropes. Further, the angle of towing direction of the gun clusters varies while dragging in the water i.e. the angle of tow is totally dependent on water speed and currents.

Therefore, there is need for the present invention in Seismic high-end surveys where extreme source positioning accuracy is required. The present invention provides a system and method that allows for accurate positioning of the sonar bells irrespective of gun depth and float arrangements. To position the individual gun clusters, the present invention proposes the use of unique signature reflectors, which will be captured by an AHRS Integrated transducer.

### SUMMARY OF THE INVENTION

In particular, the invention provides a system and methods that allows for accurate positioning of the sonar bells irrespective of gun depth and float arrangements. Further, the acoustic sensors and reflectors are positioned with fixed offsets on rigid parts rather than assumptions of offsets on flexible components.

In one embodiment, the present invention provides an active-passive acoustic source positioning within each air gun string includes a large float (approximately 15 meter) on which a cross-section stiff tube houses RGPS pods and AHRS acoustic sensors in one axis. The RGPS pods are configured to transmit surface positioning to the surface vessel, and the AHRS acoustic sensor is configured to register the motion (attitude) while in the same axis as the RGPS surface positioning device as well as transmit-receive the echo (position) from the passive reflectors placed on each of the gun clusters. The passive reflectors are reflective nodes. Further, in the lower structure of each gun string there are a number of gun clusters. On each of the gun clusters, a set of reflective nodes are positioned to provide the passive gun cluster position.

In one embodiment, the RGPS pods and AHRS acoustic sensor are “co-located” on the stiff tube, creating an axis in the cross-line vertical plane centre of the gun float, wherein the RGPS pod is positioned on a top side (on surface) of the stiff tube and an AHRS acoustic sensor is positioned on bottom side (underwater) of the stiff tube. The RGPS pods and AHRS acoustic sensors are positioned in the same axis sharing the same rigging structure on the said stiff tube, which is integrated in the gun float.

In one embodiment, the AHRS acoustic sensors include an attitude sensor allowing any tilt to be identified and corrected.

The reflective nodes are positioned along each gun string on each gun cluster position. In one embodiment, the reflective nodes are positioned with fixed offset from the center of the each gun cluster. Further in one embodiment, the positioning is resistant to air gun firing forces. Further in one embodiment, the gun clusters are fixed with the stiff tube through a fixed structure. Further in one embodiment, the reflective nodes are positioned with fixed known offsets on each individual gun cluster.

In another embodiment, the data transmission from the said integrated RGPS pods and AHRS acoustic sensors is through radio or wire to the communications unit on the surface vessel.

In another embodiment, a method of passive acoustic source positioning of sea-going platforms is disclosed. The method includes surface positioning by means of RGPS pods and the link to underwater positioning by means of an AHRS acoustic sensor on a fixed structure, with a fixed offset, for example a stiff tube. Positioning each gun cluster will be achieved by directing the sonar impulse from the AHRS to each of the reflective nodes that are positioned along the gun string in the gun cluster. Further, the RGPS pods and AHRS acoustic sensors are positioned in the same axis sharing the same rigging structure on the stiff tube.

In another embodiment, the method of operation differs from the existing methods in that the positioning equipment located in the gun clusters/individual air guns is passive. This allows the strategic precise location of this equipment in places where any active system would likely get premature damage or provides unusable data.

In another embodiment, the method of operation differs from utilization of a combination of off the shelf products and technologies to an end not previously explored.

### BRIEF DESCRIPTION OF THE DRAWINGS

The present disclosure may be better understood by reference to one or more of these drawings in combination with the detailed description presented herein;

FIG. 1 illustrates passive acoustic source positioning according to an embodiment of the present disclosure;

FIG. 2 illustrates passive acoustic source positioning with fixed offsets according to an embodiment of the present disclosure;

FIG. 3a is front view of air gun cluster according to an embodiment of the present disclosure;

FIG. 3b is a top view of air gun cluster according to an embodiment of the present disclosure;

FIG. 3c is a side view of air gun cluster according to an embodiment of the present disclosure;

and

FIG. 4 illustrates integrated RGPS pods and AHRS acoustic sensor according to an embodiment of the present disclosure.

### DETAILED DESCRIPTION OF THE INVENTION

In the following description, numerous details are set forth to provide an understanding of the present disclosure. However, it will be understood by those skilled in the art that the present disclosure may be practiced without these details and that numerous variations or modifications from the described embodiments are possible.

The present disclosure provides a system and method for accurate positioning of the sonar bells irrespective of gun depth and float arrangements. Further, the disclosure provides source positioning with known fixed offsets to position the underwater gun clusters on rigid parts rather than assumptions of offsets on flexible components.

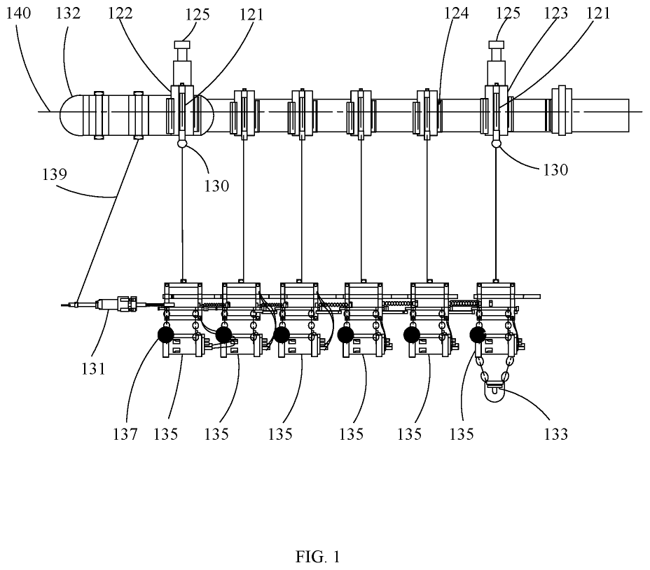

The invention will be explained with reference to the drawings. FIG. 1, illustrates a base concept of positioning acoustic source in an embodiment of the present invention. Referring to FIG. 1, a stiff tube 121 is arranged that houses Relative Global Positioning System (RGPS) pods 125 and Attitude and Heading Reference System (AHRS) acoustic sensor 130. Several air guns are included in gun strings 131. A set of reflective nodes 137 is positioned along each gun string 131 on each gun cluster 135. Each gun cluster in comprised of one or two air guns. The reflective nodes 137 will reflect the signal from an AHRS acoustic sensor 130 through the water column, the AHRS acoustic sensor 130 will accurately capture the position of reflective nodes 137 and transmit the position data to a surface vessel. In one embodiment, the AHRS acoustic sensor 130 is an AHRS Integrated Transducer (such as the ISA500). The RGPS pods 125 are configured to transmit surface positioning to the surface vessel, and the AHRS acoustic sensor 130 is configured to register the motion (attitude) while in the same axis as the RGPS pods 125 surface positioning device as well as transmit-receive the echo (position) from the passive reflectors i.e., reflective nodes 137 placed on each of the gun clusters 135. The AHRS acoustic sensor 130 is configured in order for navigation and/or location determination. The captured data i.e. position data of reflective nodes 137 is a reflected acoustic signal that is received by the AHRS acoustic sensor 130 and in combination with the RGPS pods 125 surface positioning allows the accurate observation of each reflective node 137. The AHRS acoustic sensor is configured to transmit the echoed position of each reflector to an acoustic communications unit on the surface vessel. In one embodiment, the AHRS acoustic sensors 130 include an attitude sensor allowing any tilt to be identified and corrected.

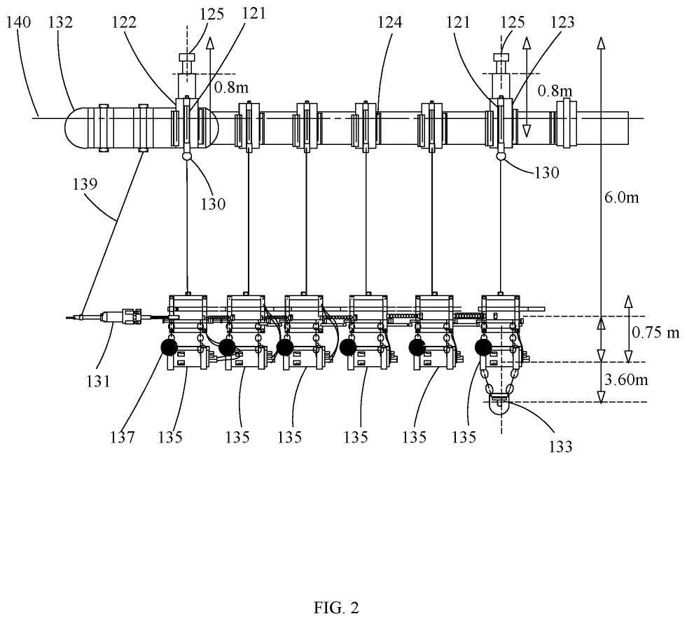

In one embodiment, the RGPS pods 125 and AHRS acoustic sensor 130 are “co-located” on the stiff tube 121, creating an axis in the cross-line vertical plane center of the gun float 132. The stiff tube 121 is a rigid part that provides a fixed structure in source positioning. A RGPS pod 125 is positioned on the top side of the stiff tube 121; and an AHRS acoustic sensor 130 is positioned on the bottom side of the stiff tube 121. As shown in the FIG. 1 and FIG. 2, one integrated RGPS pod 125 and AHRS acoustic sensor 130 is attached a first end 122 and other integrated RGPS pod 125 and AHRS acoustic sensor 130 is attached to second end 123 in the same axis sharing the same rigging structure 124 on the stiff tube 121.

FIG. 2 illustrates in details of positioning the air guns, in another embodiment of the present invention. A RGPS pod 125 is positioned on the top side of the stiff tube 121; and an AHRS acoustic sensor (130) is positioned on the bottom side of the stiff tube 121. The air gun is included gun strings 131. A reflective node 137 is positioned along each gun string 131 on each gun cluster 135. As shown in the FIG. 2, the fixed offset from head of the RGPS pod 125 to the AHRS acoustic sensors 130 is approximately 0.8 meter on the stiff tube (121). However, the fixed offset may change according to practice in other embodiments. Further, the reflective nodes 137 are positioned in the gun cluster 135 with fixed offset of approximately 0.75 meter. However, the fixed offset may changes according to practice in another embodiments. Further an active acoustic transponder 133 (a legacy active acoustic sensor) is placed in same axis along with the reflective nodes 137, the fixed offset from the reflective node 137 to active acoustic transponder 133 is 3.60 meter as recorded in this particular example of FIG. 2 although in this legacy system there's uncertainty due to flexible connecting components (i.e. chain that holds the active acoustic transponder). Further, in another embodiment, the fixed offset from head of the RGPS pod to an active acoustic transponder 133 is approximately 9.6 meter as recorded in this particular example of FIG. 2 although in this legacy system there's uncertainty due to flexible connecting components i.e. the depth ropes 139 that determine the depth of the gun string 131 relative to the gun float 132, in this example the depth rope is 6 meter and the chain length is approximately 3.6 meter, depending on configuration. In general, a rope that holds the gun strings 131 to the gun float 132 is called the depth rope 139 and it varies usually between 5-8 meter. In another embodiment, during positioning of the gun float 132 into the column of water, the stiff tube 121 is position in or around the mean sea level 140. In another embodiment, the positioning of the RGPS pod 125 and AHRS acoustic sensors 130 is resistant to air gun firing forces. In another embodiment the passive acoustic source positioning provides a measured distance between the AHRS acoustic sensor 130 and the air gun reflective nodes 137 deployed on each of the gun clusters 135, for accurate positioning.

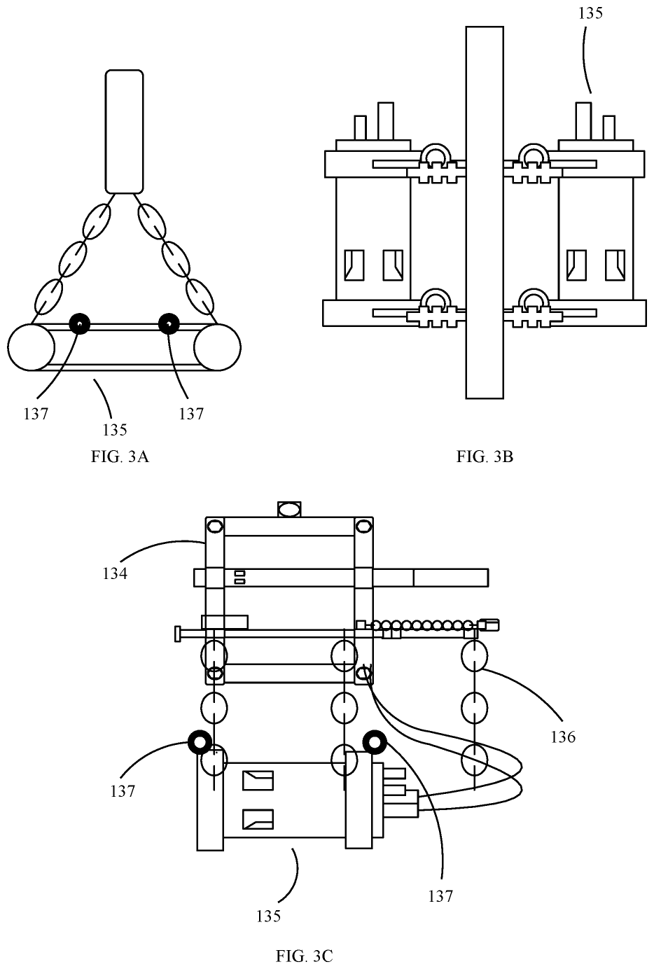

FIGS. 3a, 3b and 3c illustrate different view of the gun cluster 135 with fixed arrangements. The reflective nodes (sonar bells) 137 are positioned with a fixed offset from the center of each gun cluster 135. The reflective nodes 137 reflect a unique signature from each reflective node 137. By this arrangement of the reflective nodes 137 with a fixed offset from the center of each gun cluster 135 is resistant to gun firing forces. In another embodiment, the reflective nodes 137 are located with fixed known offsets within each individual gun cluster 135.

Further a mounting structure 134, where the air guns as well as other sensors and cables are attached via chains 136 (as shown in FIG. 3c). The air guns are hung in mounting structure 134 both solely or in pairs, forming the gun clusters 135. The chain 136 has a fixed length.

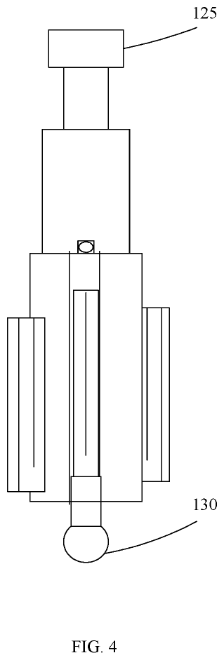

FIG. 4 illustrate integrated RGPS pods 125 and AHRS acoustic sensors 130, both RGPS pods 125 and AHRS acoustic sensors 130 are effectively “co-located” and positioned in the same axis by sharing same rigging structure (a flexible gun float with rigid rings) 124. In another embodiment, the RGPS pods 125 and AHRS acoustic sensor 130 are “co-located” on the stiff tube 121.

As shown in the FIG. 1 and FIG. 2, the air gun string 131 is attached with the gun float 132 via depth ropes. Further, an umbilical cable is attached to the gun sting 131 by connecting to a mother vessel; the umbilical cable pulls the gun strings 131 from the mother vessel. Usually the umbilical cable is deployed around 500 meters.

The data transmission form the integrated RGPS pods 125 and AHRS acoustic sensor 130 is through radio or wire to a communications unit on the surface vessel (not shown).

In various embodiments, a method of passive acoustic source positioning of sea-going platforms is disclosed. The method comprises positioning RGPS pods 125 and AHRS acoustic 130 sensor on a fixed surface for example a stiff tube 121, positioning a gun strings 131 with said RGPS pods 125 and AHRS acoustic sensors 130 with fixed offset and positioning a set of reflective nodes 137 along each gun string 131 on each gun cluster 135 position. Further, the RGPS pods 125 and AHRS acoustic sensors 130 are positioned in the same axis sharing the stiff tube 121 on the same rigging structure 124. Further positioning of said reflective nodes 137 along each gun string 131 on each gun cluster 135 positions with fixed offsets to the gun clusters 135.

The proposed method of operation differs from the existing methods in that the positioning equipment is passive. This allows the strategic precise location of this equipment in places where any active system would likely get premature damage or unusable data.

It should be apparent to persons skilled in the arts that various modifications and adaptation of this structure described above are possible without departure from the spirit of the invention the scope of which is defined in the appended claim.

1-14. (canceled)

15. A passive acoustic source positioning air gun comprising:
a stiff tube that houses RGPS pods and AHRS acoustic sensors, the said RGPS pods are configured to transmit surface positioning to an acoustic communications unit on a surface vessel,
the said AHRS acoustic sensors are configured to register motion (attitude) while in same axis as RGPS pods;
gun strings; and
a set of reflective nodes,
wherein said RGPS pods and the said AHRS acoustic sensors are “co-located” on the said stiff tube, creating an axis in the cross-line vertical plane centre of the gun float,
wherein one of the said RGPS pod is positioned on the top side and one the said AHRS acoustic sensor is positioned on the bottom side of the said stiff tube, characterized in that the said RGPS pods and AHRS acoustic sensors are positioned in the same axis sharing the same rigging structure on the said stiff tube, characterised in that the said reflective nodes are positioned along each gun string on each gun cluster position,
wherein the said reflective nodes are positioned with a fixed offset from the centre of said each gun cluster.

16. The passive acoustic source positioning of claim 15, wherein said positioning is resistant to air gun firing forces.

17. The passive acoustic source positioning of claim 15, wherein provides measured distance between the AHRS acoustic sensor and the air gun for accurate positioning.

18. The passive acoustic source positioning of claim 15, wherein further data transmission form the said integrated RGPS pods and the said AHRS acoustic sensors is through radio or wire to said communications unit on the surface vessel.

19. The passive acoustic source positioning of claim 15, wherein further the said AHRS acoustic sensors are configured to receive and transmit position from the passive reflective nodes placed on each of the gun clusters.

20. The passive acoustic source positioning of claim 15, wherein the said AHRS acoustic sensors or equivalent include an attitude sensor allowing any tilt to be identified and corrected.

21. The passive acoustic source positioning of claim 15, wherein the said reflective nodes are positioned with fixed known offsets on each individual gun cluster.

22. A method of passive acoustic source positioning comprising:
integrating RGPS pods or equivalent and AHRS acoustic sensors or equivalent on a stiff tube, the said RGPS pods transmit surface positioning to a RGPS communication unit onboard on the surface vessel and the said AHRS acoustic sensors transmits acoustic data to an acoustic communications unit on the surface vessel while also registering and transmitting motion (attitude) data while in same axis as RGPS pods;
positioning gun strings by means of observed offsets by the said RGPS pods and AHRS acoustic sensors which nave a fixed offset between them; and positioning a set of reflective nodes along each gun string on each gun cluster position;
wherein positioning of the said RGPS pods and the said AHRS acoustic sensors on said stiff tube,
wherein positioning of one the said RGPS pod is on the top side and one the said AHRS acoustic sensor is on the bottom side of the said stiff tube,
wherein positioning of the said RGPS pods and the said AHRS acoustic sensors in the same axis sharing the same rigging structure on said stiff tube; characterised in that positioning of the said reflective nodes along each gun string on each gun cluster position,
wherein positioning of the said reflective nodes with fixed offsets from the centre to said gun clusters,
wherein said RGPS pods and said AHRS acoustic sensors are a part of a towing arrangement behind the surface vessel near the surface in the sea, characterised in that the said acoustic communications unit is coupled to or integrally formed with the surface vessel.

23. The method of claim 22, wherein the said positioning is resistant to air gun firing forces.

24. The method of claim 22, wherein the said RGPS pods and AHRS acoustic sensors are “co-located” on said stiff tube.

25. The method of claim 22, wherein further provides measured distance between the AHRS acoustic sensor 130 and the reflective nodes positioned near the air gun for accurate positioning.

26. The method of claim 22, wherein further data transmission form the said integrated RGPS pods and AHRS acoustic sensors is through radio or wire to said communications unit on the surface vessel.

27. The method of claim 22, wherein the said AHRS acoustic sensors include an attitude sensor allowing any tilt to be identified and corrected.

28. The method of claim 22, wherein the reflective nodes are positioned with fixed known offsets on each individual gun cluster.
